(19) United States
(12) Patent Application Publication
(10) Pub. No.: US 2011/0086216 A1
(43) Pub. Date: Apr. 14, 2011

(54) FOAMED RESIN PRODUCT AND FOAMED RESIN MOLDING MACHINE TO MANUFACTURE THE SAME

(75) Inventors: Bong Sup LIM, Suwon-si (KR); Nam Chun SONG, Hwaseong-si (KR)

(73) Assignee: SAMSUNG ELECTRONICS CO., LTD., Suwon-si (KR)

(21) Appl. No.: 12/897,052

(22) Filed: Oct. 4, 2010

(30) Foreign Application Priority Data
Oct. 13, 2009 (KR) 10-2009-0097216

(51) Int. Cl. B32B 3/26; B29C 44/58; B29C 44/10

(52) U.S. Cl. 428/304.4; 425/4 R; 264/45.5

(57) ABSTRACT

Disclosed is a foamed resin molding machine including a first mold having a first molding surface, a second mold having a second molding surface, and a third mold. A cavity is formed between the first molding surface and the second molding surface, and the third mold is movably mounted with respect to the first molding surface, such that the third mold can protrude into the cavity. The cavity is fillable with resin particles.

### CROSS-REFERENCE TO RELATED PATENT APPLICATION

This application claims priority from Korean Patent Application No. 2009-0097216, filed on Oct. 13, 2009 in the Korean Intellectual Property Office, the disclosure of which is incorporated herein by reference.

### BACKGROUND

1. Field

Apparatuses and methods consistent with exemplary embodiments relate to a foamed resin product and a foamed resin molding machine to manufacture the same.

2. Description of the Related Art

A foamed resin molding machine may refer to a device to manufacture a product, for example, using extruded polystyrene foam (e.g., Styrofoam™). After resin particles having a predetermined diameter are manufactured through a pre-foaming process, the resin particles are fused to one another in a foamed resin molding machine containing a cavity in a shape corresponding to a product to be manufactured. Thus, the foamed resin product is manufactured in the desired shape.

A foamed resin molding machine may include a first mold having a first molding surface, a second mold having a second molding surface, and a steam supplier that supplies steam into a cavity. Pre-foamed resin particles are supplied into the cavity to fill the cavity. In this state, steam is supplied by the steam supplier and passed through the cavity. Accordingly, the resin particles are fused together by heat of the steam into the desired shape corresponding to the shape of the cavity. Thus, the foamed resin product is manufactured.

### SUMMARY

Exemplary embodiments provide a foamed resin molding machine capable of manufacturing a foamed resin product including portions with different densities.

In accordance with an aspect of an exemplary embodiment, there is provided a foamed resin molding machine including a first mold having a first molding surface, a second mold having a second molding surface, wherein a cavity is formed between the first molding surface and the second molding surface, and a third mold movably mounted with respect to the first mold, such that the third mold can protrude into the cavity.

The foamed resin molding machine may further include a steam supplier that supplies steam into the cavity, and communication holes formed in at least one of the first, second and third molds to allow the steam supplied by the steam supplier to flow through the cavity.

The first molding surface may include a depression part within which the third mold is movably mounted.

The third mold may be moveable into a position in which a third molding surface of the third mold is coplanar with the first molding surface.

The foamed resin molding machine may further include an actuator which moves the third mold forward and backward.

The first mold may be fixed at a predetermined position, and the second mold may be movable toward and away from the first mold. Alternately, the second mold may be fixed at a predetermined position, and the first mold may be moveable toward and away from the second mold.

One of the first mold and the second mold may be mounted with a resin supply pipe through which resin particles are supplied.

The foamed resin molding machine may further include a steam supply pipe which supplies steam into the cavity.

The first mold may include a first core block including the first molding surface, a first mount block, and a first chamber formed between the first core block and the first mount block, into which the steam is supplied from the steam supplier, and the second mold may include a second core block including the second molding surface, a second mount block, and a second chamber formed between the second core block and the second mount block, into which the steam is supplied from the steam supplier.

The plurality of communication holes are formed in each of the first core block, the second core block, and the third mold, allowing fluid communication between the first chamber, the second chamber, and the cavity.

In accordance with an aspect another exemplary embodiment, there is provided a foamed resin product formed by fusion of resin particles integrally including a buffer part having a relatively low density and a reinforcing part having a relatively high density.

The reinforcing part may be formed by compressing and deforming the resin particles having a circular sectional shape to have an oval sectional shape, and fused in a state where density of the resin particles is thus increased.

The buffer part may include the resin particles having a circular sectional shape, fused to one another.

### BRIEF DESCRIPTION OF THE DRAWINGS

These and/or other exemplary aspects will become apparent and more readily appreciated from the following description of exemplary embodiments, taken in conjunction with the accompanying drawings of which:

FIG. 1 is a schematic view of a foamed resin manufacturing mold according to an exemplary embodiment; and

FIG. 2 to FIG. 5 are views schematically showing operations of a foamed resin manufacturing mold according to an exemplary embodiment.

### DETAILED DESCRIPTION OF EXEMPLARY EMBODIMENTS

Reference will now be made in detail to exemplary embodiments which are illustrated in the accompanying drawings, wherein like reference numerals refer to like elements throughout.

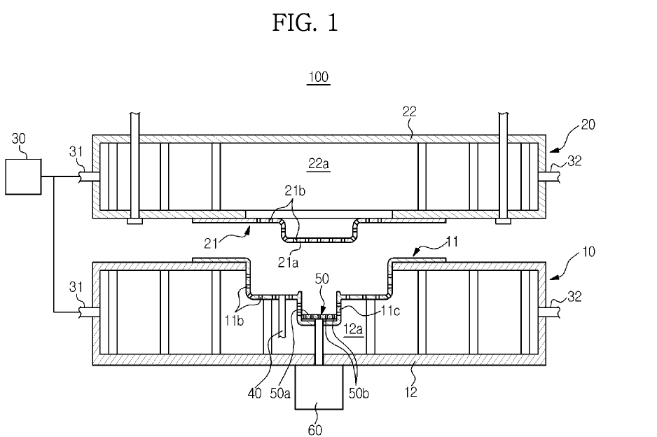

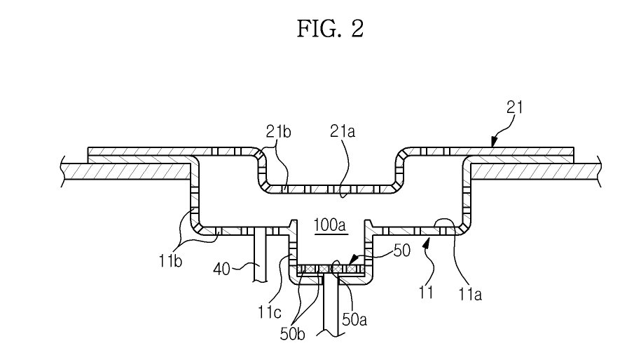

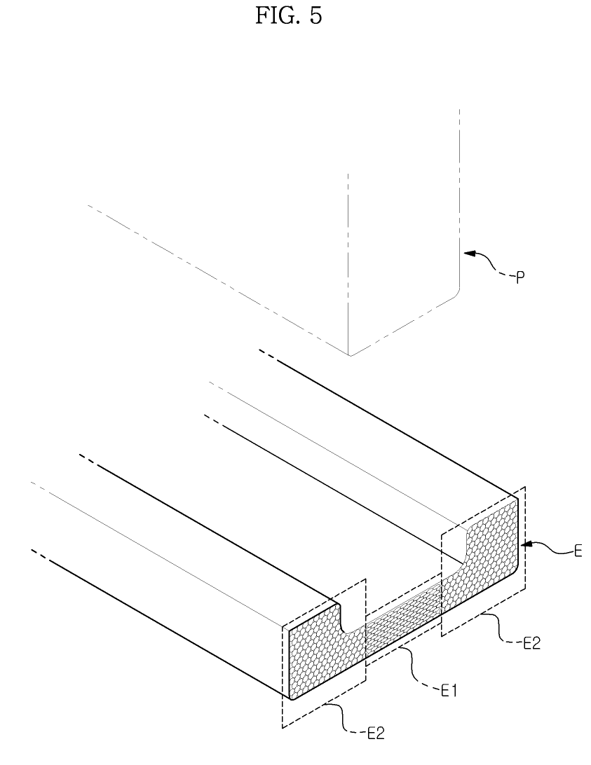

Referring to FIG. 1 and FIG. 2, a foamed resin molding machine 100 includes a first mold 10 having a first molding surface 11a shaped corresponding to one surface of a foamed resin product E to be manufactured (see FIG. 5), a second mold 20 having a second molding surface 21a facing the first molding surface 11a and shaped corresponding to the other surface of the foamed resin product E to be manufactured, and a steam supplier 30 that supplies hot steam into a cavity 100a generated by the first and the second surfaces 11a and 21a as the first mold 10 and the second mold 20 are connected.

The first mold 10 is fixed at a predetermined position. The second mold 20 is movable to and from the first mold 10. When the first mold 10 is connected to the second mold 20, the cavity 100a is formed between the first molding surface 11a and the second molding surface 21a. A resin supply pipe 40 is mounted to the first mold 10. Resin particles are pre-foamed into balls having a predetermined diameter and supplied into the cavity 100a through the resin supply pipe 40. More specifically, the resin particles are supplied into the cavity 100a by a pneumatic pressure, thereby filling the cavity 100a.

The first mold 10 includes a core block 11 forming the first molding surface 11a, and a first mount block 12 supporting the first core block 11. The second mold 20 includes a second core block 21 forming the second molding surface 21, and a second mount block 22.

The first mount block 12 and the second mount block 22, respectively, include a first chamber 12a and a second chamber 22a which receive the steam from the steam supplier 30. The first core block 11 and the second core block 21 include a plurality of first communication holes 11b and a plurality of second communication holes 21b, respectively. The first and the second chambers 12a and 22a are in fluid communication with the cavity 100a through the first and the second communication holes 11b and 21b, such that the steam can move to and from between the first or the second chamber 12a or 22a and the cavity 100a. In addition, a steam supply pipe 31 supplied with the steam from the steam supplier 30 is connected to one side of each of the first mount block 12 and the second mount block 22. A steam discharge pipe 32 is connected to the opposite sides of the first and the second mount blocks 12 and 22, respectively, to discharge the steam passed through the cavity 100a to the outside.

Foamed resin products E manufactured by the foamed resin molding machine 100 may be used as packing materials of various goods P as shown in FIG. 5, so as to protect the goods P from external shocks to which they may be subjected during transportation. Considering that the foamed resin product E may be used as packing material or as a shock absorbing material for the goods P, a certain portion of the foamed resin product E, to which weight of the goods P will be directly applied, may be formed to have greater strength than another portion of the foamed resin product E.

To this end, the foamed resin molding machine 100 according to an exemplary embodiment is designed to integrally manufacture a foamed resin product E having a relatively low-strength portion and a relatively high-strength portion.

For this purpose, as shown in FIG. 1 and FIG. 2, the first mold 10 is provided with a third mold 50 which is movably mounted and can protrude into the cavity 100a charged with the resin particles. The third mold 50 includes a third molding surface 50a shaped corresponding to one side of a portion of the foamed resin product E, the portion requiring high strength, and a plurality of third communication holes 50b allowing steam to flow therethrough.

A depression part 11c is formed by the core block 11 adjacent to the first molding surface 11a of the first mold 10, so that the third mold 50 may be mounted in the depression part 11c and may be movable up and down within the depression part 11c. Also, an actuator 60, operated by pneumatic pressure, is mounted to the first mold 10. The third mold 50 is moved up and down by the actuator 60.

The third mold 50 is moved up by the actuator 60 and protrudes into a part of the cavity 100a, that is, the depression part 11c, thereby pressing the resin particles disposed in the cavity 100a at an upper part of the third mold 50.

The third mold 50 is moveable to a position in which the third molding surface 50a of the third mold 50 is aligned with the first molding surface 11a, in other words, so that the third molding surface 50a is coplanar with the first molding surface 11a. Accordingly, the foamed resin product E can be shaped so that a side formed by the first molding surface 11a and a side formed by the third molding surface 50a are coplanar with each other. Therefore, the side of the foamed resin product E formed by the first and the third molding surfaces 11a and 50a may be simultaneously supported by a planar surface on which the foamed resin product E is rested.

Hereinafter, the operations of the foamed resin molding machine 100 will be described with reference to the accompanying drawings.

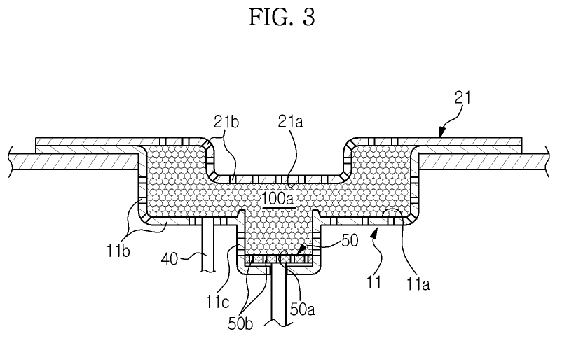

FIG. 2 illustrates a state in which the first mold 10 and the second mold 20 are interconnected, and resin particles are supplied into the cavity 100a through the resin supply pipe 40. As a result, the cavity 100a is filled with the resin particles as shown in FIG. 3. During these operations, the third mold 50 is maintained at a lowered position so that the depression part 11c is also filled with the resin particles.

After the cavity 100a is fully filled with the resin particles, the resin supply pipe 40 is closed and steam is supplied into the first and the second chambers 12a and 22a through the steam supply pipes 31. The steam supplied to the first and the second chambers 12a and 22a is passed through the cavity 100a through the communication holes 11b, 21b and 50b respectively formed in the first core block 11, the second block 21 and the third mold 50, and then discharged to the outside through the steam discharge pipes 32. While the steam is passing through the cavity 100a, the resin particles are fused together by heat of the steam, thus manufacturing a foamed resin product E corresponding to the shape of the cavity 100a.

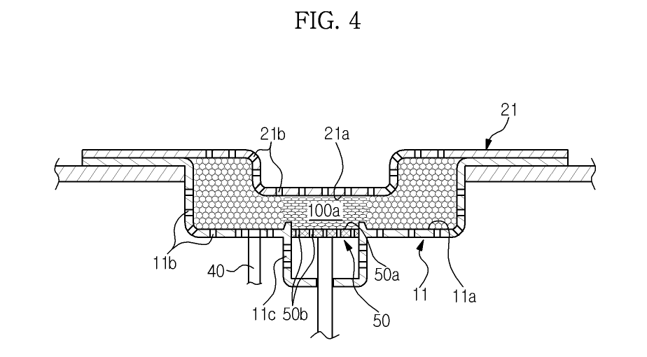

While the resin particles are being fused by the steam supplied into the cavity 100a, simultaneously, the third mold 50 is moved upward by the actuator 60 as shown in FIG. 4 and protruded into a part of the cavity 100a, that is, the depression part 11c. Since the inside of the cavity 100a is filled with the resin particles, the resin particles disposed at the upper part of the third mold 50, that is, in front of the moving direction of the third mold 50, are compressed by the force moving the third mold 50. Therefore, the resin particles having a circular cross-sectional shape are deformed to have an oval cross-sectional shape. As a result, a density of the resin particles is increased in the area in front of the moving direction of the third mold 50.

Thus, the resin particles disposed at other portions of the cavity 100a (portions other than in front of the third mold 50) maintain circular cross-sectional shapes, whereas the resin particles disposed in front of the moving direction of the third mold 50 are deformed to have oval cross-sectional shapes. In this state, the resin particles are fused to one another by the heat of the steam.

The foamed resin product E thus manufactured through the foamed resin molding machine 100 is divided into one portion, disposed in front of the moving direction of the third mold and having the oval sectional shape, and the other portion in which the circular cross-sectional shapes of the particles are maintained. Therefore, the portion disposed in front of the moving direction of the third mold forms a reinforcing part E1 having a density and strength greater than the other portions of the foamed resin product E. On the other hand, the other portions of the foamed resin product E (those portions other than the reinforcing part E1) form a buffer part E2 having a relatively low density and strength which can be more easily resiliently deformed.

Therefore, a foamed resin molding machine 100 according to the exemplary embodiment described herein is capable of efficiently manufacturing a foamed resin product E integrally having the reinforcing part E1 with high density and strength and the buffer part E2 with low density and strength, through a single molding process.

According to the described exemplary embodiment, the depression part 11c is formed and the third molding surface 50a of the third mold 50 is moved to the position coplanar with the first molding surface 11a, such that the side formed by the first molding surface 11a is coplanar with the side formed by the third molding surface 50a. However, the third molding surface 50a of the third mold 50 may protrude from the first molding surface 11a so that the side of the foamed resin product E formed by the third molding surface 50a is depressed compared to the side formed by the first molding surface 11a.

According to the above exemplary embodiment, the third mold 50 is mounted to the first mold 10 which is fixed. However, the third mold 50 may be mounted to the second mold 20 which is movable.

As is apparent from the above description, in accordance with a foamed resin molding machine according to a described exemplary embodiment, a third mold protrudes within the cavity after the cavity is charged with resin particles. Therefore, the resin particles disposed in front of a moving direction of the third mold are compressed and increased in density. Thus, a foamed resin product integrally having a portion with relatively high strength and density and a portion with relatively low strength and density can be manufactured through a single molding process.

Although a few exemplary embodiments have been shown and described, it would be appreciated by those skilled in the art that changes may be made in these embodiments without departing from the principles and spirit of the inventive concept, the scope of which is defined in the claims and their equivalents.

1. A foamed resin molding machine comprising:
a first mold including a first molding surface;
a second mold including a second molding surface, wherein a cavity is formed between the first molding surface and the second molding surface; and
a third mold that is movably mounted to the first molding surface, such that the third mold is moveable to protrude into the cavity.

2. The foamed resin molding machine according to claim 1, further comprising:
a steam supplier that supplies steam into the cavity; and
communication holes formed in at least one of the first, second and third molds, through which steam supplied by the steam supplier flows through the cavity.

3. The foamed resin molding machine according to claim 1, wherein the first mold comprises a depression part within which the third mold is movably mounted.

4. The foamed resin molding machine according to claim 3, wherein the third mold is moveable to a position in which so that a third molding surface of the third mold is coplanar with the first molding surface.

5. The foamed resin molding machine according to claim 1, further comprising an actuator which moves the third mold forward and backward.

6. The foamed resin molding machine according to claim 1, wherein the first mold is fixed at a predetermined position, and the second mold is movable toward and away from the first mold.

7. The foamed resin molding machine according to claim 1, wherein the second mold is fixed at a predetermined position, and the first mold is moveable toward and away from the second mold.

8. The foamed resin molding machine according to claim 1, further comprising a resin supply pipe, through which resin particles are supplied, mounted to one of the first mold and the second mold.

9. The foamed resin molding machine according to claim 1, further comprising a steam supply pipe through which steam is supplied into the cavity.

10. The foamed resin molding machine according to claim 2, wherein:
the first mold comprises a first core block comprising the first molding surface, a first mount block, and a first chamber, formed between the first core block and the first mount block, into which steam is supplied from the steam supplier, and
the second mold comprises a second core block comprising the second molding surface, a second mount block, and a second chamber, formed between the second core block and the second mount block, into which steam is supplied from the steam supplier.

11. The foamed resin molding machine according to claim 10, the communication holes are formed in each of the first core block, the second core block, and the third mold, allowing fluid communication between the first chamber, the second chamber, and the cavity.

12. A foamed resin product formed by fusion of resin particles, integrally comprising a buffer part and a reinforcing part, wherein a density of the buffer part is lower than a density of the reinforcing part.

13. The foamed resin product according to claim 12, wherein the reinforcing part is formed by compressing and deforming the resin particles having a circular sectional shape to have an oval sectional shape, and fusing the resin particles thus compressed and deformed.

14. The foamed resin product according to claim 12, wherein the buffer part comprises the resin particles having a circular sectional shape, fused to one another.

15. A method of manufacturing a foamed resin product, the method comprising:
forming a cavity between a first mold and a second mold, the cavity bordered by a first molding surface of the first mold, a third molding surface, of the first mold, and a second molding surface of the second mold;
filling the cavity with resin particles;
fusing the resin particles by simultaneously:
injecting steam into the cavity, and
moving the third molding surface with respect to the first molding surface, such that the third molding surface projects into the cavity compressing resin particles, such that resin particles disposed in a first region, adjacent to the third molding surface, are compressed to a greater extent than resin particles disposed in a second region, outside the first region.

16. The method according to claim 15, wherein the forming the cavity comprises moving one of the first mold and the second mold such that the first mold and the second mold are brought into contact with each other with the cavity formed therebetween.

17. The method according to claim 15, wherein the moving the third molding surface comprises using pneumatic pressure.

18. The method according to claim 15, wherein the moving the third molding surface comprises moving the third molding surface from a first position, in which the third molding surface is disposed within a depression in the first mold and is recessed with respect to the first molding surface, to a second position in which the third molding surface is coplanar with the first molding surface.

19. A method of manufacturing a foamed resin product, the method comprising:
forming a cavity having at least a first portion and a second portion, different from the first portion;
filling the cavity with resin particles; and
simultaneously injecting steam into the cavity, and increasing a density of resin particles in the first portion of the cavity with respect to a density of resin particles in the second portion of the cavity by compressing the first portion of the cavity.

20. A foamed resin molding machine comprising:
a cavity into which resin particles and steam are injectable;
wherein the cavity is bounded by at least one fixed molding surface and at least one moveable molding surface; and
wherein the at least one moveable molding surface is moveable between a first position, in which a volume of the cavity is a first volume, and a second position, in which a volume of the cavity is a second volume, less than the first volume.
